(19) United States
(12) Patent Application Publication
(10) Pub. No.: US 2018/0241196 A1
(43) Pub. Date: Aug. 23, 2018

(54) A SMART OVERVOLTAGE PROTECTION CIRCUIT AND A METHOD THEREOF

(71) Applicant: GREENSTAR RESEARCH AND DEVELOPMENT INDIA PRIVATE LIMITED, GURGAON, HARYANA (IN)

(72) Inventors: JYOTIRMOY CHAKRAVARTY, BOERNE, TX (US); SAROSIJ SENGUPTA, GURGAON, HARYANA (IN); LALIT KUMAR SINGH, NEW DELHI (IN)

(21) Appl. No.: 15/745,569

(22) PCT Filed: Jul. 22, 2016
(86) PCT No.: PCT/IB2016/054374

§ 371 Date: Jan. 17, 2018

(30) Foreign Application Priority Data
Jul. 22, 2015 (IN) 2213/DEL/2015

(51) Int. Cl. H02H 3/20; H02H 1/00; H02H 3/04

(52) U.S. Cl. CPC H02H 3/20; H02H 3/04; H02H 1/0061; H02H 1/0007

(57) ABSTRACT

The present invention provides a smart overvoltage protection circuit (100) comprising an AC power line (110), at least one switch (120) connected to the AC power line (110) and an overvoltage detection module (130) connected to the at least one switch (120) and the AC power 0 line (110). Further, the overvoltage detection module (130) comprises a voltage divider (210), a sensing circuitry (220) and a control module (230) such that the voltage divider (210) is configured to divide voltage of the AC power line (110) to obtain divided voltage, the sensing circuitry (220) is configured to generate a first output signal and a second output signal 5 and the control module (230) is configured to receive the first output signal and the second output signal and turn the at least one switch (120) from a closed position to an open position in response to receiving the first output signal.

### FILED OF THE INVENTION

Embodiments of the present invention relate to overvoltage protection in AC power lines and more particularly to a smart overvoltage protection circuit and a method for protecting appliances from overvoltage conditions in the AC power line.

### BACKGROUND OF THE INVENTION

An overvoltage condition in an electrical installation occurs when voltage in a particular installation zone rises above a rated voltage for that zone. Fluctuation in voltage that is generally greater than 10% above rated voltage is considered to be an overvoltage condition. In overvoltage condition, the electrical and electronic devices connected to the installation zone are all exposed to damage. As electronic and electrical devices are designed to operate at a certain rated voltage, considerable damage can be caused by sustained overvoltage, that is, voltage higher than that for which the devices are rated. Electrical, Electronics and Digital circuits are especially very susceptible to prolonged overvoltage conditions.

Overvoltage conditions are characterized by the peak voltage and the duration. According to IEEE 1159/1995 standard, increased voltage with range from 110% to 120% of the nominal voltage and for duration longer than one minute are termed as overvoltage conditions. Other high voltage conditions where the amplitude of the voltages are extremely high ranging from 1 KV to 10 KV or even 20 KV for very short durations of microseconds are termed as a surge or a spike condition. For surge or spike conditions, some solutions like surge arresters, spike busters, are known in the art. However there is still no reliable solution to protect the appliances from an overvoltage condition in an AC power line.

Accordingly, there remains a need in the prior art to have an over voltage protection circuit which overcomes the aforesaid problems and shortcomings.

### SUMMARY OF THE INVENTION

Embodiments of the present invention aim to provide an overvoltage protection circuit and a method for overvoltage protection. The invention provides effective overvoltage protection and allows keeping record of the history of the overvoltage conditions in one or more AC power lines in an electrical installation zone.

In accordance with an embodiment of the present invention, a smart overvoltage protection circuit comprises an AC power line, at least one switch connected to the AC power line and an overvoltage detection module connected to the at least one switch and the AC power line. Further, the overvoltage detection module comprises a voltage divider, a sensing circuitry and a control module such that the voltage divider is configured to divide voltage of the AC power line to obtain divided voltage, the sensing circuitry is configured to generate a first output signal indicative of the divided voltage being greater than a predetermined threshold value and a second output signal indicative of the divided voltage being smaller than the predetermined threshold value and the control module is configured to receive the first output signal and the second output signal and turn the at least one switch from a closed position to an open position in response to receiving the first output signal.

In accordance with an embodiment of the present invention, the control module is configured to turn the at least one switch from the open position to the closed position in response to receiving the second output signal.

In accordance with an embodiment of the present invention, the control module is configured to indicate to a user, a condition of the voltage of the AC power line.

In accordance with an embodiment of the present invention, the smart overvoltage protection circuit comprises an energy management module configured to determine a value of electrical power being delivered by the AC power line when the at least one switch is in closed position and transmit the value of the electrical power to the control module. Further the control module is configured to record a timestamp and the value of the electrical power at completion of a predetermined interval of time and at an instance of receiving of the first output signal and the second output signal and store the timestamp and the value of the electrical power.

In accordance with an embodiment of the present invention, the control module is configured to transmit the timestamp and the value of the electrical power to a central repository.

In accordance with an embodiment of the present invention, the control module is configured to receive the predetermined threshold value from a user and communicate the predetermined threshold value to the sensing circuitry.

In accordance with an embodiment of the present invention, the control module is configured to manage a remote load using a remote communication device connected to the remote load.

In accordance with an embodiment of the present invention, a method for smart overvoltage protection, comprises the steps of providing an AC power line, connecting at least one switch to the AC power line and connecting an overvoltage detection module to the at least one switch and the AC power line. Further, the overvoltage detection module comprises a voltage divider, a sensing circuitry and a control module such that the voltage divider divides voltage of the AC power line to obtain divided voltage, the sensing circuitry generates a first output signal indicative of the divided voltage being greater than a predetermined threshold value and a second output signal indicative of the divided voltage being smaller than the predetermined threshold value and the control module receives the first output signal and the second output signal and turns the at least one switch from a closed position to an open position in response to receiving the first output signal.

In accordance with an embodiment of the present invention, the control module turns the at least one switch from the open position to the closed position in response to receiving the second output signal.

In accordance with an embodiment of the present invention, the control module indicates to a user, a condition of the voltage of the AC power line.

In accordance with an embodiment of the present invention, the method comprises the step of providing an energy management module. Further, the energy management module determines a value of electrical power being delivered by the AC power line when the at least one switch is in the closed position and transmits the value of the electrical power to the control module. Further, the control module records a timestamp and the value of the electrical power at completion of a predetermined interval of time and at an instance of receiving of the first output signal and the second output signal and stores the timestamp and the value of the electrical power.

In accordance with an embodiment of the present invention, the control module transmits the timestamp and the value of the electrical power to a central repository.

In accordance with an embodiment of the present invention, the control module receives the predetermined threshold value from a user and communicates the predetermined threshold value to the sensing circuitry.

In accordance with an embodiment of the present invention, the control module manages a remote load using a remote communication device connected to the remote load.

### BRIEF DESCRIPTION OF THE DRAWINGS

So that the manner in which the above recited features of the present invention can be understood in detail, a more particular description of the invention, briefly summarized above, may have been referred by embodiments, some of which are illustrated in the appended drawings. It is to be noted, however, that the appended drawing illustrate only typical embodiments of this invention and are therefore not to be considered limiting of its scope, for the invention may admit to other equally effective embodiments.

These and other features, benefits, and advantages of the present invention will become apparent by reference to the following text figure, with like reference numbers referring to like structures across the views, wherein:

FIG. 1 illustrates a smart overvoltage protection circuit in accordance with an embodiment of the present invention.

FIG. 2 illustrates an overvoltage detection module in accordance with an embodiment of the present invention.

FIG. 3 illustrates a control module in accordance with an embodiment of the present invention.

FIG. 4 illustrates an energy management module in accordance with an embodiment of the present invention.

FIG. 5 illustrates a portion of the smart overvoltage protection circuit in accordance with another embodiment of the present invention.

FIG. 6 illustrates a method for overvoltage protection in accordance with an embodiment of the present invention.

FIG. 7 illustrates a smart overvoltage protection circuit in accordance with an exemplary embodiment of the present invention.

FIG. 8 illustrates a smart overvoltage protection circuit in accordance with another exemplary embodiment of the present invention.

### DETAILED DESCRIPTION OF THE DRAWINGS

While the present invention is described herein by way of example using embodiments and illustrative drawings, those skilled in the art will recognize that the invention is not limited to the embodiments of drawing or drawings described, and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprises” is considered synonymous with the terms “including” or “containing” for applicable legal purposes. Any discussion of documents, acts, materials, systems, articles and the like is included in the specification solely for the purpose of providing a context for the present invention. It is not suggested or represented that any or all of these matters form part of the prior art base or were common general knowledge in the field relevant to the present invention.

In this disclosure, whenever a composition or an element or a group of elements is preceded with the transitional phrase “comprises”, it is understood that we also contemplate the same composition, element or group of elements with transitional phrases “consisting of”, “consisting”, “selected from the group of consisting of, “including”, or “is” preceding the recitation of the composition, element or group of elements and vice versa.

The present invention is described hereinafter by various embodiments with reference to the accompanying drawing, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only, and are not intended to limit the scope of the claims. In addition, a number of materials are identified as suitable for various facets of the implementations. These materials are to be treated as exemplary, and are not intended to limit the scope of the invention.

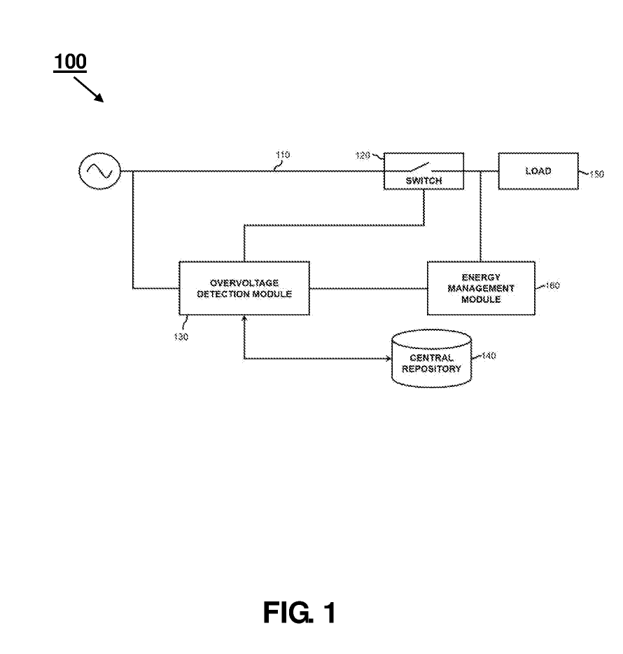

Referring to the drawings, the invention will now be described in more detail. In accordance with an embodiment of the present invention, a smart overvoltage protection circuit (100) as shown in FIG. 1 comprises, an AC power line (110). The AC power line (110) may be connected to AC power grid networks that may serve city wide requirements. The AC power line (110) provides AC current necessary to power the load (150). The AC current is provided to the load (150) via at least one switch (120) connected to the AC power line (110). The at least one switch is one of, but not limited to, a relay or a circuit breaker. Further, the smart overvoltage protection circuit (100) comprises an overvoltage detection module (130) connected to the at least one switch (120) and the AC power line (110). The overvoltage detection module (130) can be understood in detail from the following figure.

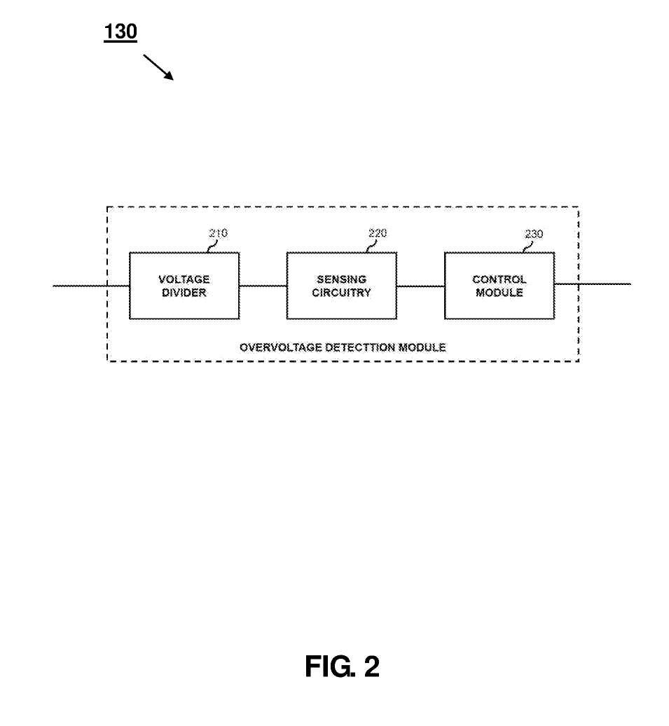

FIG. 2 illustrates the overvoltage detection module (130) in accordance with an embodiment of the present invention. As shown in the FIG. 2, the overvoltage detection module (130) comprises a voltage divider (210), a sensing circuitry (220) and a control module (230). The voltage divider (210) is configured to divide voltage of the AC power line (110) to obtain divided voltage. In accordance with an embodiment, the voltage divider (210) includes a series of resistors and/or capacitors configured to be opened and closed at any intermediate point. By tapping the resistors and/or capacitors according to predefined settings, the voltage divider (210) is configured to reduce a magnitude of the voltage to a predefined fraction. This is required so that the voltage may be easily measured. Specifically, the voltage divider (210) may scale down the voltage with a very high magnitude to an input range of the sensing circuitry (220). This way the voltage divider (210) is particularly suited for detecting the overvoltage conditions.

The sensing circuitry (220) is configured to generate a first output signal indicative of the divided voltage being greater than a predetermined threshold value. Further, the sensing circuitry (220) is configured to generate a second output signal indicative of the divided voltage being smaller than the predetermined threshold value. In accordance with an embodiment, the sensing circuitry (220) comprises a voltmeter configured to measure the divided voltage and generate the first output signal and the second output signal based on measurement of the divided voltage. In accordance with another embodiment, the sensing circuitry (220) comprises an integrated circuit with a plurality of logic gates etched onto the integrated circuit.

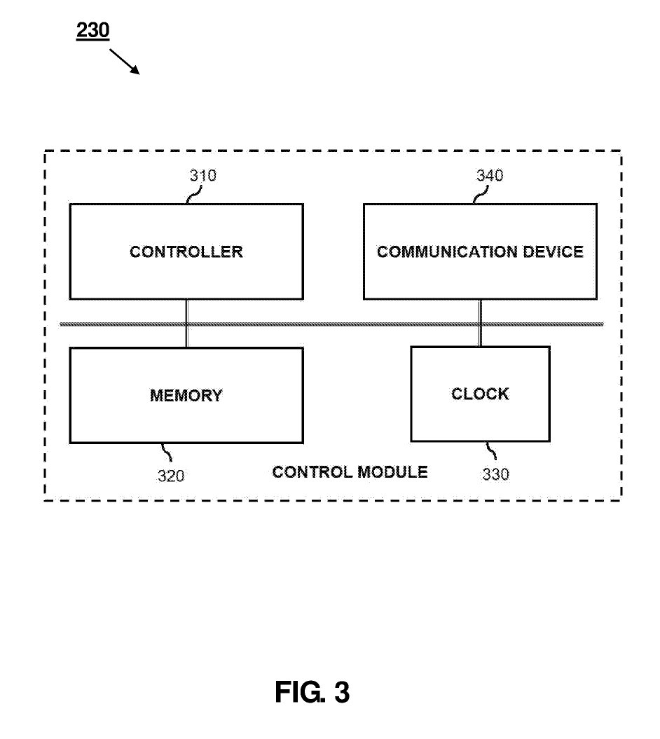

FIG. 3 illustrates the control module (230) in accordance with an embodiment of the present invention. The control module (230) comprises a controller (310), a memory (320), a clock (330) and a communication device (340). The controller (310) is operably connected to the memory (320), the clock (330) and the communication device (340). In accordance with an embodiment, the controller (310) is a logic unit having one of, but not limited to, a processor, a microprocessor or a microcontroller. The memory (320) is a non-volatile memory, such as, but not limited to EPROM, EEPROM and flash memory. Further, the clock (330) is one of, but not limited to, a quartz oscillator or a silicon oscillator. Also the communication device (340) is capable of communicating through a plurality of communication mediums such as, but not limited to, GSM, Wi-Fi, Bluetooth and Ru-Bee etc.

In accordance with an embodiment of the present invention, the configuration of the control module (230) involves writing in the memory (320), a plurality of instructions to be executed by the controller (310).

The control module (230) is configured to receive the first output signal and the second output signal and turn the at least one switch (120) from a closed position to an open position in response to receiving the first output signal. In accordance with an embodiment, the controller (310) is enabled by the plurality of instructions to turn the at least one switch (120) from the closed position to the open position. It may be understood that the predetermined threshold value corresponds to a maximum allowable voltage limit designed for the smart overvoltage protection circuit (100).

In accordance with an embodiment of the present invention, the control module (230) is configured to turn the at least one switch (120) from the open position to the closed position in response to receiving the second output signal. In accordance with an embodiment, the controller (310) is enabled by the plurality of instructions to turn the at least one switch (120) from the open position to the closed position.

In accordance with an embodiment of the present invention, the control module (230) is configured to indicate to a user, a condition of the voltage of the AC power line (110). In accordance with the embodiment, the plurality of instructions, when executed by the controller (310), enable the controller (310) to indicate to a user, a condition of the voltage of the AC power line (110). In one embodiment, the controller (310) indicates the overvoltage condition by switching on a red LED indicator connected to the controller (310). Similarly, the controller (310) indicates a normal voltage condition by switching on a green LED indicator. Also the controller (310) indicates an active state of the overvoltage detection module (130) by switching on a yellow LED indicator. It may be noted that the overvoltage detection module (130) is active when the controller (310) receives the first output signal from the sensing circuitry (220) for at least two consecutive instances.

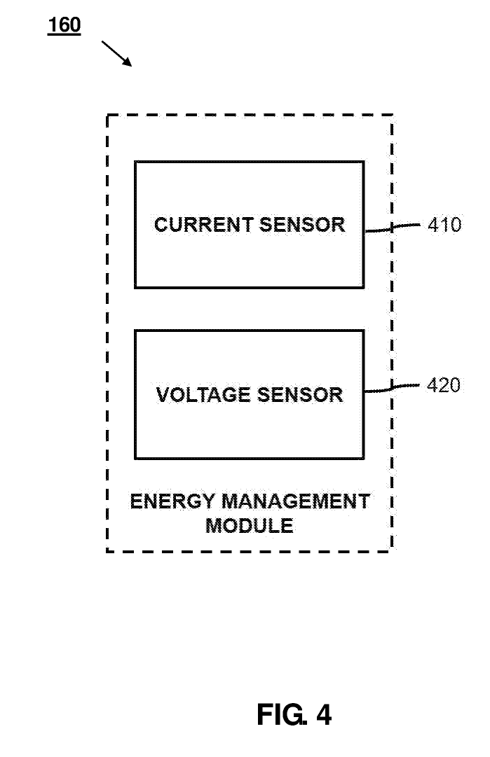

In accordance with an embodiment of the present invention, the smart overvoltage protection circuit (100) comprises an energy management module (160). The energy management module (160) is configured to determine a value of electrical power being delivered by the AC power line (110) when the at least one switch (120) is in closed position. FIG. 4 illustrates the energy management module (160) in accordance with an embodiment of the present invention. As shown in FIG. 4, the energy management module (160) comprises a current sensor (410) and the voltage sensor (420).

When the at least one switch (120) is in closed position, the current sensor (410) measures a value of the current being supplied to the load (150) and the voltage sensor (420) measures a value of the voltage in the AC power line (110). The energy management module (160) determines the value of the electrical power from the value of the current and the value of the voltage. Further, the energy management module (160) is configured to transmit the value of the electrical power to the control module (230).

The control module (230) is configured to record a timestamp and the value of the electrical power at completion of a predetermined interval of time and at an instance of receiving of the first output signal and the second output signal. Further, the control module (230) is configured to store the timestamp and the value of the electrical power. In accordance with an embodiment, the plurality of instructions enable the controller (310) to record the timestamp using the clock (330) and the value of the electrical power received from the energy management module (160), at the completion of the predetermined interval of time and at the instance of receiving the first output signal and the second output signal. Further, the controller (310) is enabled to store the timestamp and the value of the electrical power in the memory (320).

In accordance with an embodiment of the present invention, the predetermined interval of time depends on the circuit requirements and may range from, but not limited to, 10 ms to 1 s.

In accordance with an embodiment, the control module (230) is configured to transmit the timestamp and the value of the electrical power to a central repository (140). In accordance with an embodiment, the plurality of instructions enable the controller (310) to transmit the timestamp and the value of the electrical power to the central repository (140) using the communication device (340). Further, in accordance with an embodiment of the present invention, the central repository (140) is a database server configured to store the timestamp and the value of the electrical power in a database.

In accordance with an embodiment of the present invention, the control module (230) is configured to monitor the voltage in the AC power line (110) after a regular interval of time. The regular interval of time may vary between, but not limited to, 1 minute to 2 hour. In accordance with an embodiment, the energy management module (160) is configured to transmit the value of the voltage to the control module (230), at completion of the regular interval of time. Further, the plurality of instructions enable the controller (310) to receive the value of the voltage from the energy management module (160). Also, the plurality of instructions enable the controller (310) to transmit the value of the voltage to the central repository (140).

In accordance with an embodiment, the control module (230) is configured to receive the predetermined threshold value from the user and communicate the predetermined threshold value to the sensing circuitry (220). In accordance with an embodiment, the plurality of instructions enable the controller (310) to receive the predetermined threshold value from the user using the communication device (340). Also the controller is enabled by the plurality of instructions to communicate the predetermined threshold value to the sensing circuitry (220).

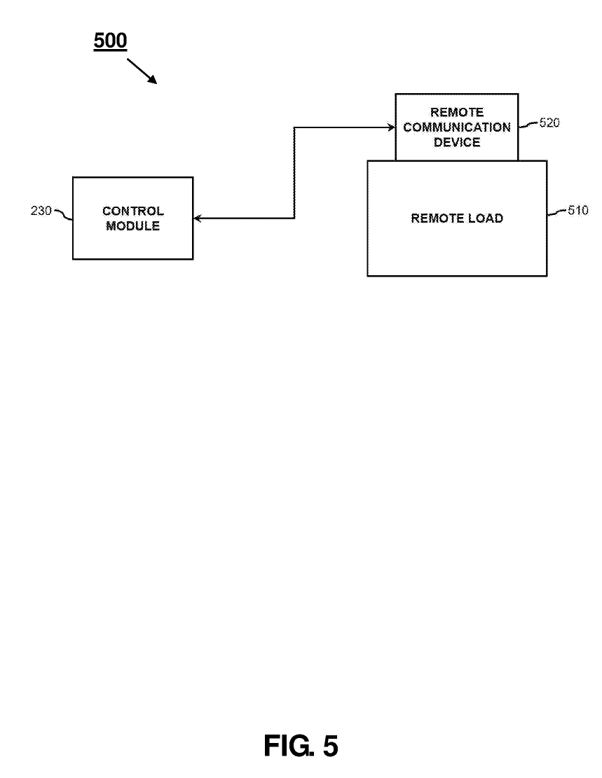

FIG. 5 illustrates a portion of the smart overvoltage protection circuit in accordance with an embodiment (500) of the present invention. As shown in FIG. 5, a remote load (510) is connected to a remote communication device (520). The remote communication device (520) is capable of communicating through a plurality of communication mediums such as, but not limited to, GSM, Wi-Fi, Bluetooth and Ru-Bee etc. The control module (230) is further in communication with the remote communication device (520). The control module (230) is configured to manage the remote load (510) using the remote communication device (520). In accordance with an embodiment, the plurality of instructions enable the controller (310) to communicate with the remote communication device (520) using the communication device (340), in order to manage the remote load (510). The management of the remote load (510) comprises, but is not limited to, switching the remote load (510) on and off, regulating power supply to the remote load (510) and tracking the location of the remote load (510) in a wide installation zone of the city.

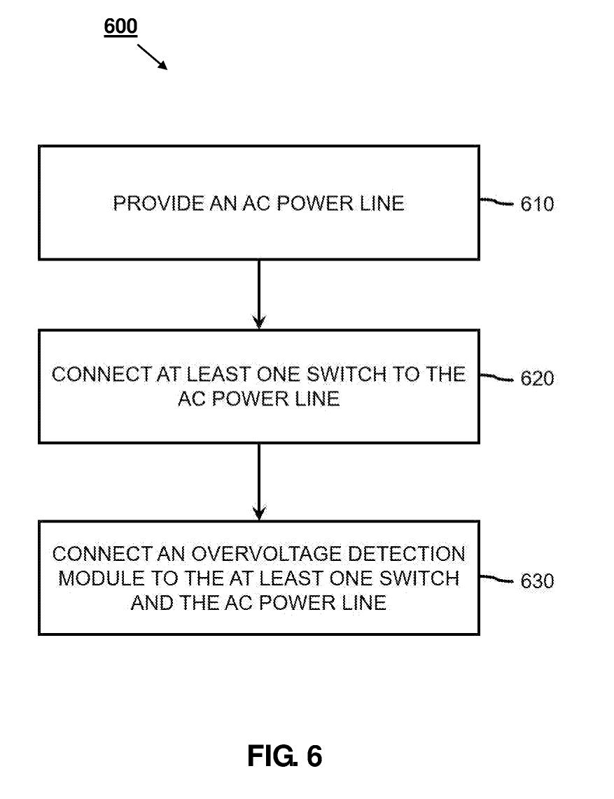

FIG. 6 illustrates a method (600) for smart overvoltage protection in accordance with an embodiment of the present invention. The method begins at step 610 by providing the AC power line (110). The AC power line (110) may be connected to AC power grid networks that may serve city wide requirements. The AC power line (110) provides AC current necessary to power the load (150).

At step 620, the at least one switch (120) is connected to the AC power line (110). At step 430, an overvoltage detection module (130) is connected to the at least one switch (120) and the AC power line (110). The overvoltage detection module (130) comprises a voltage divider (210), a sensing circuitry (220) and a control module (230). The voltage divider (210) divides voltage of the AC power line (110) to obtain divided voltage. Further, the sensing circuitry (220) generates a first output signal indicative of the divided voltage being greater than a predetermined threshold value and a second output signal indicative of the divided voltage being smaller than the predetermined threshold value. Also the control module (230) receives the first output signal and the second output signal and turns the at least one switch (120) from a closed position to an open position in response to receiving the first output signal. In accordance with an embodiment, the controller (310) turns the at least one switch (120) from the closed position to the open position.

In accordance with an embodiment of the present invention, the control module (230) turns the at least one switch (120) from the open position to the closed position in response to receiving the second output signal. In accordance with an embodiment, the controller (310) turns the at least one switch (120) from the open position to the closed position.

In accordance with an embodiment of the present invention, the control module (230) indicates to a user, a condition of the voltage of the AC power line (110). In accordance with an embodiment, the controller (310) indicates the overvoltage condition by switching on a red LED indicator connected to the controller (310). Similarly, the controller (310) indicates a normal voltage condition by switching on a green LED indicator. Also the controller (310) indicates an active state of the overvoltage detection module (130) by switching ON a yellow LED indicator. It may be noted that the overvoltage detection module (130) is active when the controller (310) receives the first output signal for at least two consecutive instances.

In accordance with an embodiment of the present invention, the energy management module (160) is provided. The energy management module (160) determines a value of electrical power being delivered by the AC power line (110) when the at least one switch (120) is in the closed position. In accordance with an embodiment, when the at least one switch (120) is in closed position, the current sensor (410) measures a value of the current being supplied to the load (150) and the voltage sensor (420) measures a value of the voltage in the AC power line (110). The energy management module (160) determines the value of the electrical power from the value of the current and the value of the voltage. Further, the energy management module (160) transmits the value of the electrical power to the control module (230).

Further, the control module (230) records a timestamp and the value of the electrical power at completion of a predetermined interval of time and at an instance of receiving of the first output signal and the second output signal. Also the control module (230) stores the timestamp and the value of the electrical power. In accordance with an embodiment, the controller (310) records the timestamp using the clock (330 and the value of the electrical power received from the energy management module (160), at the completion of the predetermined interval of time and at the instance of receiving the first output signal and the second output signal. Further, the controller (310) stores the timestamp and the value of the electrical power in the memory (320).

In accordance with an embodiment of the present invention, the control module (230) transmits the timestamp and the value of the electrical power to the central repository (140). In accordance with an embodiment, the controller (310) transmits the timestamp and the value of the electrical power to the central repository (140) using the communication device (340).

In accordance with an embodiment of the present invention, the control module (230), receives the predetermined threshold value from the user and communicates the predetermined threshold value to the sensing circuitry (220). In accordance with an embodiment, the controller (310) receives the predetermined threshold value from the user using the communication device (340). Also the controller (310) communicates the predetermined threshold value to the sensing circuitry (220).

In accordance with an embodiment of the present invention, the control module (230) manages the remote load (510) using the remote communication device (520) connected to the remote load (510). In accordance with an embodiment, the controller (310) communicates with the remote communication device (520) using the communication device (340), in order to manage the remote load (510).

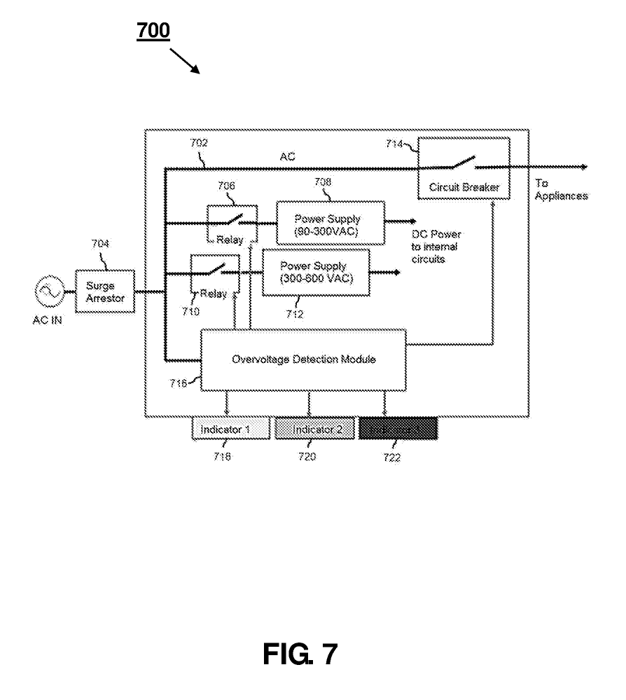

FIG. 7 illustrates the smart overvoltage protection circuit (100) in accordance with an exemplary embodiment (700) of the present invention. As shown in FIG. 7, the embodiment (700) comprises an AC power line (702). A surge arrester (704) is connected to the AC power line (702). The surge arrester (704) is configured to protect the embodiment (700) from surge or spike conditions in the AC power line (702). Further, the embodiment (700) comprises two relays, a first relay (706) and a second relay (710). The first relay (706) is connected to a first power supply (708) rated to deliver DC power to internal circuits at lower potential. The second relay (710) is connected to a second power supply (712) rated to deliver DC power to internal circuits at higher potential.

In an exemplary embodiment, the first power supply (708) is rated to deliver DC power between 90-300 VAC, and the second power supply (712) is rated to deliver DC power between 300-600 VAC. The first relay (706) and the second relay (710) are configured to open and close the embodiment (700) of the smart overvoltage protection circuit (100) based on the detected overvoltage conditions. Further, the embodiment (700) comprises a circuit breaker (714). The circuit breaker (714) is an automatically operated electrical switch designed to protect appliances from damage caused by the overvoltage condition. The circuit breaker (714) generally acts in response to a detection of the overvoltage condition in the supply line, and may open to interrupt the AC power supply to the appliances. The details of the operation of the circuit breaker (714) are well known in the art, and thus have been avoided herein for the brevity of the disclosure.

Further, the embodiment (700) comprises the overvoltage detection module (716) connected to the AC power line (702), the first relay (706), the second relay (710) and the circuit breaker (714). The overvoltage detection module (716) is configured to actuate the embodiment (700) of the smart overvoltage protection circuit (100) using the first relay (706), the second relay (710) and the circuit breaker (714) during an overvoltage condition. The overvoltage detection module (716) is also configured to indicate to the user, a condition of the voltage of the AC power line (702) using the first indicator (718), the second indicator (720) and the third indicator (722). The first indicator (718) may be a green LED, the second indicator (720) may be a yellow LED and the third indicator (722) may be a red LED.

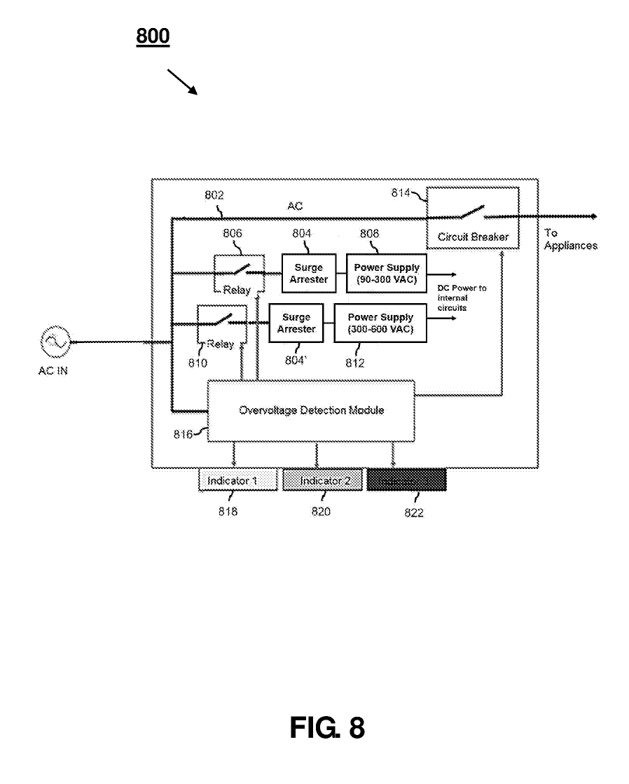

FIG. 8 illustrates the smart overvoltage protection circuit (100) in accordance with an exemplary embodiment (800) of the present invention. As shown in FIG. 8, the embodiment (800) comprises an AC power line (802). Further, the embodiment (800) comprises two relays, a first relay (806) and a second relay (810). The first relay (806) is connected to a first power supply (808) rated to deliver DC power to internal circuits at lower potential. The second relay (810) is connected to a second power supply (812) rated to deliver DC power to internal circuits at higher potential.

In an exemplary embodiment, the first power supply (808) is rated to deliver DC power between 90-300 VAC, and the second power supply (812) is rated to deliver DC power between 300-600 VAC. A first surge arrester (804) is connected to the first power supply (808) and a second surge arrester (804′) is connected to the second power supply (812). The first surge arrester (804) and the second surge arrester (804′) are configured to protect the embodiment (800) from surge or spike conditions in the first power supply (808) and the second power supply (812) respectively. The first relay (806) and the second relay (810) are configured to open and close the embodiment (800) of the smart overvoltage protection circuit (100) based on the detected overvoltage conditions. Further, the embodiment (800) comprises a circuit breaker (814). The circuit breaker (814) is an automatically operated electrical switch designed to protect appliances from damage caused by an overload or a short circuit due to the overvoltage condition. The circuit breaker (814) generally acts in response to a detection of the overvoltage condition in the supply line, and may open to interrupt the AC power supply to the appliances. The details of the operation of the circuit breaker (814) are well known in the art, and thus have been avoided herein for the brevity of the disclosure.

Further, the embodiment (800) comprises the overvoltage detection module (816) connected to the AC power line (802), the first relay (806), the second relay (810) and the circuit breaker (814). The overvoltage detection module (816) is configured to actuate the embodiment (800) of the smart overvoltage protection circuit (100) using the first relay (806), the second relay (810) and the circuit breaker (814) during an overvoltage condition. The overvoltage detection module (816) is also configured to indicate to the user, a condition of the voltage of the AC power line (802) using the first indicator (818), the second indicator (820) and the third indicator (822). The first indicator (818) may be a green LED, the second indicator (820) may be a yellow LED and the third indicator (822) may be a red LED

The smart overvoltage protection circuit and the method for overvoltage protection offers a plurality of advantages. The smart overvoltage protection circuit and the method for smart overvoltage protection of the present invention may be configured to detect the overvoltage conditions in the AC power line and protect the appliances connected to the AC power line from such conditions. Further, the smart overvoltage protection circuit and the method for overvoltage protection may be configured to keep a record of the history of the overvoltage conditions in one or more AC power lines in an electrical installation zone.

The smart overvoltage protection circuit and the method for overvoltage protection may be configured to transmit record information including time logs of overvoltage condition to the central database server. This feature may particularly be used for diagnostic purposes. For example, in one embodiment, every 30 household in a city may be installed with the smart overvoltage protection circuit of the present invention. In that case, the central database server may receive record of overvoltage conditions of every household, and in general of every electrical installation zone in the city. The city's electrical board may use that information to diagnose the power lines and the associated units where there are more frequent problems of the overvoltage conditions. Further, this feature may particularly be used to count the events of the overvoltage condition and returning to the normal condition to get a life estimation of the switches of the smart overvoltage protection circuit. This feature may be used for timely maintenance of the electromechanically operated switches.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention and appended claim.

1. A smart overvoltage protection circuit (100) comprising:
an AC power line (110);
at least one switch (120) connected to said AC power line (110); and
an overvoltage detection module (130) connected to said at least one switch (120) and said AC power line (110);
wherein said overvoltage detection module (130) comprises a voltage divider (210), a sensing circuitry (220) and a control module (230) such that:
said voltage divider (210) is configured to divide voltage of said AC power line (110) to obtain divided voltage;
said sensing circuitry (220) is configured to generate a first output signal indicative of said divided voltage being greater than a predetermined threshold value and a second output signal indicative of said divided voltage being smaller than said predetermined threshold value; and
said control module (230) is configured to receive said first output signal and said second output signal and turn said at least one switch (120) from a closed position to an open position in response to receiving said first output signal.

2. The smart overvoltage protection circuit (100) as claimed in claim 1, wherein said control module (230) is configured to turn said at least one switch (120) from said open position to said closed position in response to receiving said second output signal.

3. The smart overvoltage protection circuit (100) as claimed in claim 1, wherein said control module (230) is configured to indicate to a user, a condition of said voltage of said AC power line (110).

4. The smart overvoltage protection circuit (100) as claimed in claim 1, comprising an energy management module (160) configured to:
determine a value of electrical power being delivered by said AC power line (110) when said at least one switch (120) is in closed position; and
transmit said value of said electrical power to said control module (230);
wherein said control module (230) is configured to:
record a timestamp and said value of said electrical power at completion of a predetermined interval of time and at an instance of receiving of said first output signal and said second output signal; and
store said timestamp and said value of said electrical power.

5. The smart overvoltage protection circuit (100) as claimed in claim 4, wherein said control module (230) is configured to transmit said timestamp and said value of said electrical power to a central repository (140).

6. The smart overvoltage protection circuit (100) as claimed in claim 1, wherein said control module (230) is configured to:
receive said predetermined threshold value from a user; and
communicate said predetermined threshold value to said sensing circuitry (220).

7. The smart overvoltage protection circuit (100) as claimed in claim 1, wherein said control module (230) is configured to manage a remote load (510) using a remote communication device (520) connected to said remote load (510).

8. A method (600) for smart overvoltage protection, comprising the steps of:
providing (610) an AC power line (110);
connecting (620) at least one switch (120) to said AC power line (110); and
connecting (630) an overvoltage detection module (130) to said at least one switch (120) and said AC power line (110);
wherein said overvoltage detection module (130) comprises a voltage divider (210), a sensing circuitry (220) and a control module (230) such that:
said voltage divider (210) divides voltage of said AC power line (110) to obtain divided voltage;
said sensing circuitry (220) generates a first output signal indicative of said divided voltage being greater than a predetermined threshold value and a second output signal indicative of said divided voltage being smaller than said predetermined threshold value; and
said control module (230) receives said first output signal and said second output signal and turns said at least one switch (120) from a closed position to an open position in response to receiving said first output signal.

9. The method (600) as claimed in claim 8, wherein said control module (230) turns said at least one switch (120) from said open position to said closed position in response to receiving said second output signal.

10. The method (600) as claimed in claim 8, wherein said control module (230) indicates to a user, a condition of said voltage of said AC power line (110).

11. The method (600) as claimed in claim 8, comprising the step of providing an energy management module (160), wherein said energy management module (160):
determines a value of electrical power being delivered by said AC power line (110) when said at least one switch (120) is in said closed position; and
transmits said value of said electrical power to said control module (230);
wherein said control module (230):
records a timestamp and said value of said electrical power at completion of a predetermined interval of time and at an instance of receiving of said first output signal and said second output signal; and
stores said timestamp and said value of said electrical power.

12. The method (600) as claimed in claim 11, wherein said control module (230) transmits said timestamp and said value of said electrical power to a central repository (140).

13. The method (600) as claimed in claim 8, wherein said control module (230):
receives said predetermined threshold value from a user; and
communicates said predetermined threshold value to said sensing circuitry (220).

14. The method (600) as claimed in claim 8, wherein said control module (230) manages a remote load (510) using a remote communication device (520) connected to said remote load (510).
